(19) United States
(12) Patent Application Publication
(10) Pub. No.: US 2025/0349946 A1
(43) Pub. Date: Nov. 13, 2025

(54) MULTI-FUNCTIONAL PRISMATIC BATTERY CELL HOUSING

(71) Applicant: GM Global Technology Operations LLC, Detroit, MI (US)

(72) Inventors: Lu Huang, Troy, MI (US); Mary Gilliam, Farmington Hills, MI (US); Hui-ping Wang, Troy, MI (US); Selina Xinyue Zhao, Rochester Hills, MI (US); Ryan Curtis Sekol, Grosse Pointe Woods, MI (US); Xiaosong Huang, Novi, MI (US)

(73) Assignee: GM Global Technology Operations LLC, Detroit, MI (US)

(21) Appl. No.: 18/661,250

(22) Filed: May 10, 2024

(51) Int. Cl. H01M 50/124; B60L 50/64; H01M 10/613; H01M 10/625; H01M 10/6561; H01M 50/103; H01M 50/119; H01M 50/122; H01M 50/209

(52) U.S. Cl. CPC H01M 50/124; B60L 50/64; H01M 10/613; H01M 10/625; H01M 10/6561; H01M 50/103; H01M 50/119; H01M 50/122; H01M 50/209; H01M 2220/20

(57) ABSTRACT

A prismatic cell having a cell housing, comprising an inner shell, comprising a first side wall and a second side wall spaced from the first side wall, an upper wall coupled to the first side wall and the second side wall, a lower wall coupled to the first side wall and the second side wall, and an inner side and an outer side opposite the inner side. The prismatic cell further comprising an outer shell coupled to the outer side of the inner shell, one or more cavities between the inner shell and the outer shell, and one or more cooling channels arranged in the one or more cavities and coupled to the outer side of the inner shell. The one or more cavities comprising at least one first fluid conduit on a first side of the cooling channels and at least one second fluid conduit on a second side of the cooling channels.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery packs for electric vehicles and, more particularly, to a multifunctional prismatic cell.

In general, Rechargeable Energy Storage Systems (RESS) typically include one or more battery cells with insulating jackets, an elastic material between the one or more cells, a thermal interface material, and/or a cooling interface. As a result, these systems can occupy a large amount of space within a vehicle. Further, assembly and packaging these systems can be complex due to the number of components and the large footprint required to package the system in a vehicle. One or more aspects of the present disclosure address shortcomings of existing systems.

### SUMMARY

In one configuration, a prismatic cell having a cell housing is provided and includes an inner shell including a first side wall and a second side wall spaced from the first side wall, an upper wall coupled to the first side wall and the second side wall, a lower wall coupled to the first side wall and the second side wall, and an inner side and an outer side opposite the inner side. The prismatic cell further including an outer shell coupled to the outer side of the inner shell, one or more cavities between the inner shell and the outer shell, and one or more cooling channels arranged in the one or more cavities and coupled to the outer side of the inner shell. The one or more cavities including at least one first fluid conduit on a first side of the cooling channels and at least one second fluid conduit on a second side of the cooling channels.

The prismatic cell may include one or more of the following optional aspects. For example, the prismatic cell can further include one or more electrodes and an electrolyte arranged within the inner shell.

In at least one aspect, the inner shell can further include a lining coupled to the inner side. The lining can be made of a fluoropolymer material.

In at least another aspect, the inner shell can further include a first closure coupled to the walls at a first end of the cell housing and a second closure coupled to the walls at a second end of the cell housing.

In at least one example, the inner shell can be made of a material consisting of an aluminum alloy material or a steel material.

In at least another example, at least a portion of the outer side of the inner shell includes a mechanically abraded, rough, textured, or chemically modified surface.

In at least one aspect, the one or more cooling channels can be configured to flex in a direction perpendicular to the first and second side walls.

In at least another aspect, the first fluid conduit is configured for a first fluid and the second fluid conduit is configured for a second fluid different than the first fluid.

In at least one example, the outer shell can be a composite material.

In at least another example, the outer shell can further include one or more terminals.

According to at least one aspect, the outer shell can further include one or more vents.

The prismatic cell can further include a first end cap coupled to the upper wall and a second end cap coupled to the lower wall. The prismatic cell can further include a third end cap coupled to a front end and a fourth end cap coupled to a rear end. The third end cap can include a fluid inlet and one or more fluid outlets and the fourth end cap can include a fluid outlet and one or more fluid inlets.

In another configuration, a prismatic cell is provided and includes an inner shell, an outer shell encapsulating the inner shell, one or more cavities arranged between the inner shell and the outer shell, and one or more cooling channels arranged in the one or more cavities and coupled to the inner shell. The one or more cooling channels can be configured to flex between the inner shell and the outer shell.

The prismatic cell may include one or more of the following optional aspects. For example, the one or more cooling channels can define a first fluid conduit and a second fluid conduit within the one or more cavities.

In yet another configuration, an electric vehicle is provided and includes a vehicle body extending in a cross-car direction, an electric motor, a battery pack connected to the electric motor, and one or more prismatic cells disposed inside of the battery pack. The one or more prismatic cells include an inner shell, including a first side wall and a second side wall spaced from the first side wall, an upper wall coupled to the first side wall and the second side wall, a lower wall coupled to the first side wall and the second side wall, and an inner side and an outer side opposite the inner side. The prismatic cell further including an outer shell coupled to the outer side of the inner shell, one or more cavities between the inner shell and the outer shell, and one or more cooling channels arranged in the one or more cavities and coupled to the outer side of the inner shell.

The electric vehicle may include one or more of the following optional aspects. For example, the one or more prismatic cells extend about half of a width of the vehicle with respect to the cross-car direction or about half of a length of the vehicle with respect to the fore-aft direction.

In at least one aspect, the one or more prismatic cells extend about a width of the vehicle with respect to the cross-car direction or about a length of the vehicle with respect to the fore-aft direction.

### BRIEF DESCRIPTION OF THE DRAWINGS

The drawings described herein are for illustrative purposes only of selected configurations and are not intended to limit the scope of the present disclosure.

FIG. 1 is a schematic perspective view of an example of an electric vehicle with a battery pack in accordance with principles of the present disclosure;

FIG. 2 is a schematic end view of an example of the battery pack of FIG. 1 where a closure and an end cap of one prismatic cell is shown removed;

FIG. 3 is a perspective view of one of the prismatic cells of the battery pack of FIG. 2 having a first end cap and a second end cap;

FIG. 4 is a cross-sectional view of the prismatic cell of FIG. 3 along line 4-4 including an inner shell, one or more cooling channels, and an outer shell, first and second end caps are not shown;

FIG. 5 is cross-sectional view of another configuration of the prismatic cell of FIG. 3 including an inner shell, a lining along an inner side of the inner shell, one or more cooling channels, and an outer shell, first and second end caps are not shown;

FIG. 6 is an end view of one of the prismatic cells of the battery pack of FIG. 2 where the closure is shown coupled to the inner shell and the end cap is removed;

FIG. 7 is a cross-sectional view of the prismatic cell of FIG. 3 showing one configuration of the one or more cooling channels;

FIG. 8 is a cross-sectional view of the prismatic cell of FIG. 3 showing another configuration of the one or more cooling channels;

FIG. 9 is a cross-sectional view of the prismatic cell of FIG. 3 along line 9-9 of FIG. 3 including one or more terminals and one or more vents;

FIG. 10 is a perspective view of a battery pack including prismatic cells that are configured to extend about half of a width of the vehicle of FIG. 1; and

FIG. 11 is a perspective view of a battery pack including prismatic cells that are configured to extend across about the width of the vehicle of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

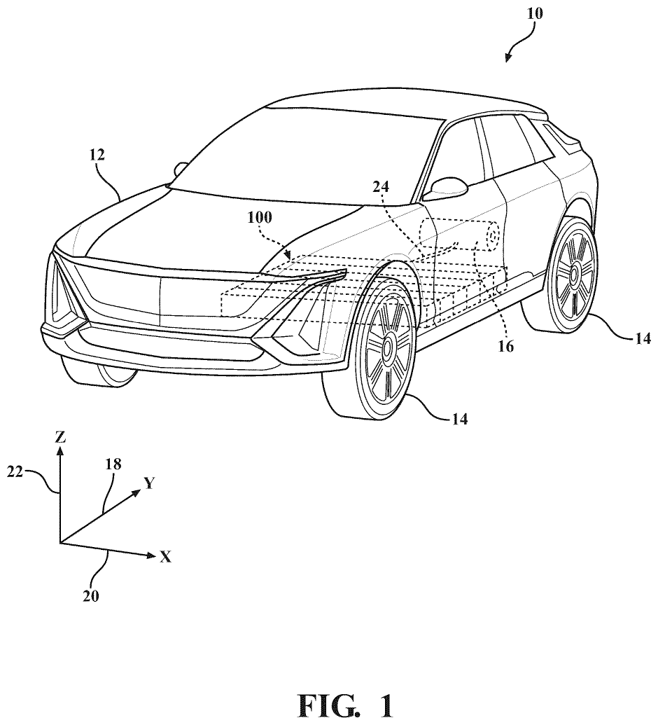

With reference to FIG. 1, a vehicle 10, such as an electric motor vehicle, is provided. The vehicle 10 includes a vehicle body 12, one or more wheels 14, and an electric motor 16 arranged in the vehicle body 12. The vehicle body 12 extends in a first direction (i.e., a fore-aft or longitudinal direction) 18, a second direction (i.e., a cross-car or lateral direction) 20, and a third direction (i.e., a vertical direction) 22. The electric motor 16 may be configured to drive one or more of the one or more wheels 14 to propel the vehicle 10. The vehicle 10 includes a battery pack 100 that can be arranged in the vehicle body 12 and is communicatively coupled to the electric motor 16 via an electric power cable 24.

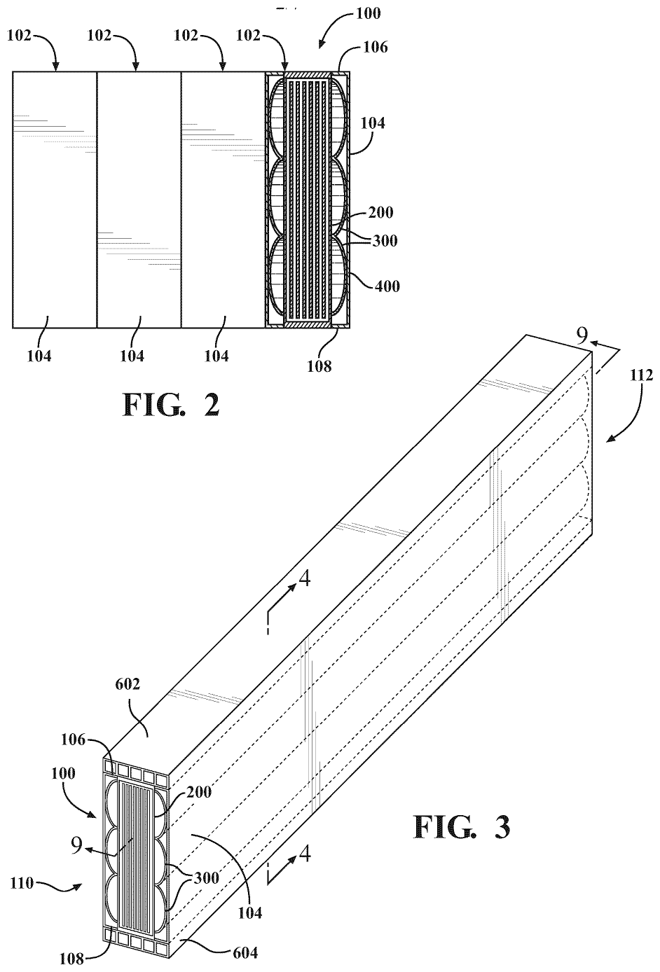

With reference to FIG. 2, an example of the battery pack 100 is provided and includes one or more cells or prismatic cells 102. Each prismatic cell 102 can include a cell housing 104. The cell housing 104 can include a sandwich structure having an inner shell 200, one or more cooling channels 300, and an outer shell 400. The cell housing 104 can be manufactured using one or more materials such as composite materials, metallic materials, or other materials that can provide structural rigidity and facilitate elastic deformation during cell formation and charging cycles, for example. Each cell housing 104 has a first or top side wall 106 and a second or bottom side wall 108, as shown in FIG. 2. Additionally, the cell housing 104 has a first or front end 110 and a second or rear end 112, as shown in FIG. 3.

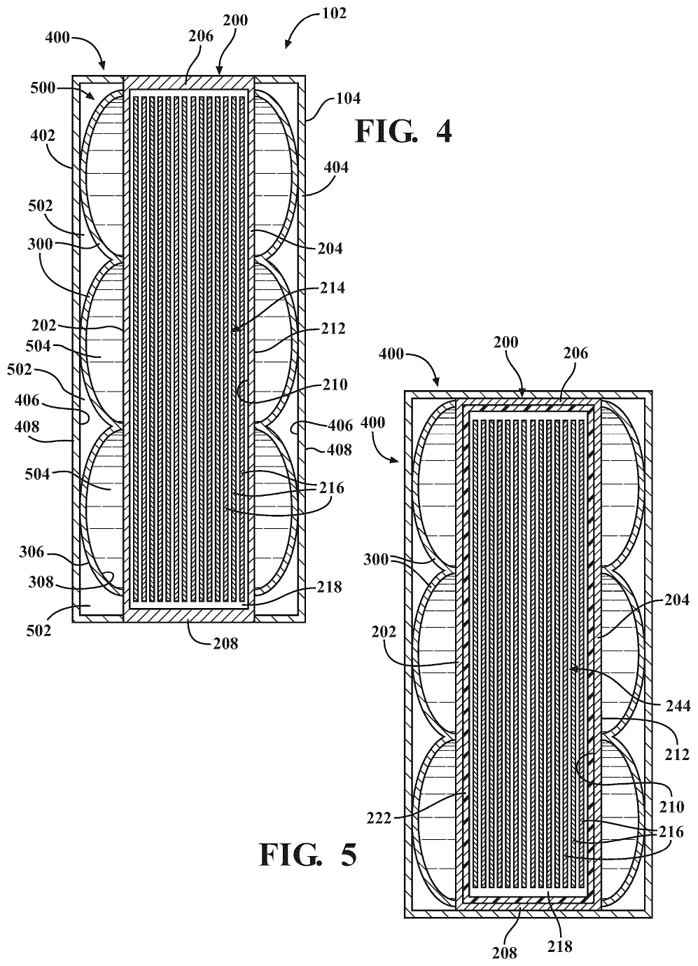

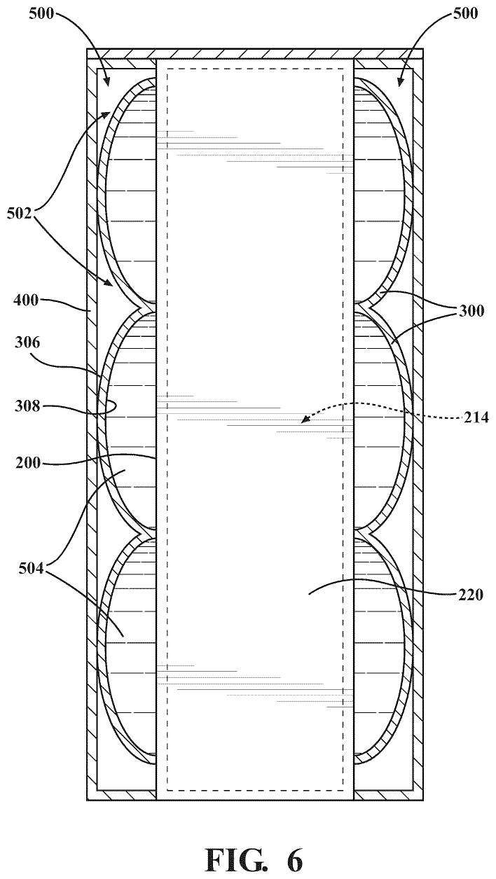

With reference to FIG. 4, the inner shell 200 can have a first side wall 202, a second wall side 204, an upper wall 206 coupled to the first side wall 202 and the second side wall 204, and a lower wall 208 coupled to the first side wall 202 and the second side wall 204. The first side wall 202, the second side wall 204, the upper wall 206, and the lower wall 208 may collectively be referred to as the walls 202, 204, 206, 208 throughout the remainder of the description. The inner shell 200 has an inner side 210 and an opposite outer side 212. More particularly, each of the walls 202, 204, 206, 208 further defines the inner side 210 and the outer side 212. The walls 202, 204, 206, 208 form a chamber 214 which can include battery cell internal components such as electrodes 216 and an electrolyte 218. With reference to FIG. 6, the chamber 214 can be a fluid-tight chamber that is sealed with one or more closures (i.e., plates) 220, for example. The closures 220 may be secured to the walls 202, 204, 206, 208 via an adhesive, welding, brazing, or another joining technique. The inner shell 200 can be manufactured using a metallic material and/or a material that is thermally conductive to facilitate cooling. The material for inner shell 200 can also be resistant to high temperatures. Materials such as aluminum alloys or steels, may be especially desirable to facilitate high thermal conductivity and/or to prevent a thermal runaway event. A portion or all of the outer side 212 of the walls 202, 204, 206, 208 may be modified to enhance heat transfer between the inner shell 200 and the outer shell 400. For example, the outer side 212 of the walls 202, 204, 206, 208 can be mechanically abraded, roughened, and/or textured to increase a surface area and/or chemically modified to enhance interfacial bonding at least where the outer shell 400 contacts or is coupled with the inner shell 200 (discussed in more detail below). More specifically, the outer side 212 can be modified using mechanical sanding, abrasion, roughening, texturing, plasma treatment, plasma deposition, laser ablation, and/or other chemical surface treatment, for example.

According to one aspect of the present disclosure, the inner shell 200 can have a lining 222, such as a chemically inert fluoropolymer lining, along the inner side 210 of the walls 202, 204, 206, 208, as shown in FIG. 5. The lining 222 may include one or more materials that are chemically resistant to the electrolyte 218 such as, Polyvinylidene fluoride (PVDF), Polytetrafluoroethylene (PTFE), Polyvinyl fluoride (PVF), or Fluorinated ethylene propylene (FEP). According to at least one aspect of the present disclosure, the lining 222 can be injection molded along the inner side 210 of the walls 202, 204, 206, 208.

With reference again to FIG. 4, the one or more cooling channels 300 can be coupled to the inner shell 200 to enhance efficiency of cooling the inner shell 200. The one or more cooling channels 300 can be made with composite or metallic materials with good thermal conductivity and elastic characteristics and can be defined by a generally arcuate wall. The arcuate wall may extend from a first end in contact with one of the walls 202, 204 to a second end in contact with the one of the walls 202, 204. An approximate midpoint of the arcuate wall may be in contact with the outer shell 400 between the first end and the second end, as shown in FIG. 4. The metallic materials for the one or more cooling channels 300 can include 3xxx aluminum alloys, other aluminum alloys, or steels, for example. The composite materials for the one or more cooling channels 300 can include those that provide strength and stiffness in the direction perpendicular to the length (i.e., dimension between the first side wall 106 and the second side wall 108 of the cell) of the cell housing 104. In other words, the cooling channels 300 can be configured to absorb deformation in the direction that is perpendicular to the first and second side walls 106, 108. Additionally or alternatively, the composite materials can include those that provide elastic characteristics in a direction normal to the first and second side walls 202, 204. The composite material can include those with fiber reinforcement or liquid crystal aromatic polyester-arylate (LCP) fibrils oriented along the length of the cell housing 104. With LCP, this can be achieved using processing conditions in which the viscosity of the matrix melt is at least two times the viscosity of the LCP melt at the processing conditions. The composite materials can include those that provide thermal conductivity, but are electrically insulating, such as those filled with aluminum oxide, boron nitride, or a thermally conductive grade, such as Zenite®, and possess a thermal resistance across the wall no greater than 3.0×10⁻³ m²KW⁻¹ at 65° C.

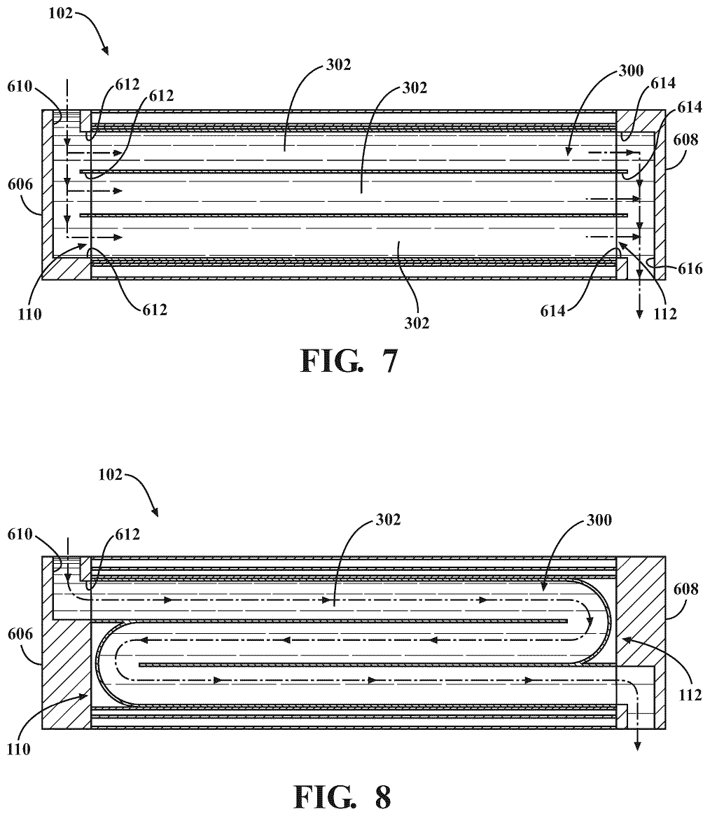

With reference to FIGS. 7 and 8, the cooling channels 300 can include one or more different paths. For instance, the cooling channels 300 can include one or more linear cooling pathways 302, as shown in FIG. 7. Alternatively, the cooling channels 300 can follow a snake-like cooling pathway 304, as shown in FIG. 8. According to an aspect of the present disclosure, a method of manufacturing the cooling channels 300 includes using water soluble sand or sacrificial fibers (e.g., a nylon monofilament) treated with a release agent.

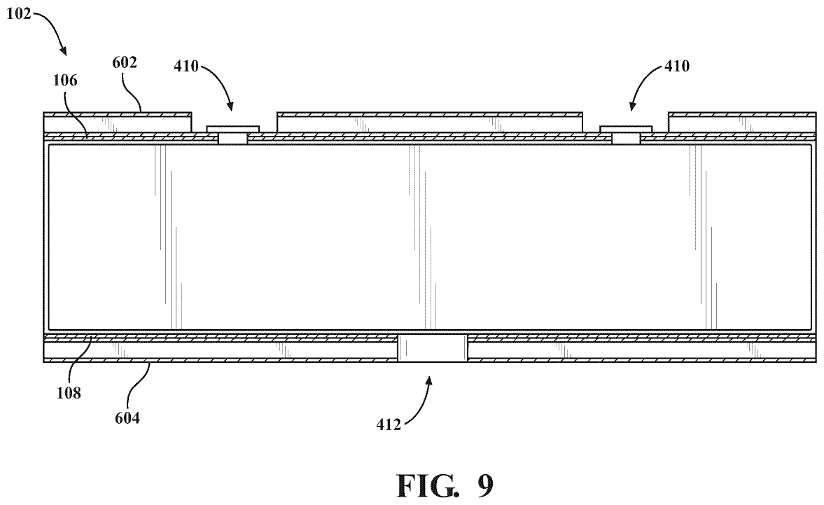

With reference again to FIG. 4, the outer shell 400 can include a first half 402 and a second half 404. The first half 402 and the second half 404 can be coupled or formed to the inner shell 200. The first half 402 and the second half 404 each include an inner wall 406 and an outer wall 408. The outer shell 400 can serve as an electrical and/or thermal barrier to isolate the prismatic cell 102 from other components of the battery pack 100. The outer shell 400 can be made with electrically and thermally resistant composite materials for insulation. Additional layers and/or coatings can be applied to the outer shell 400 to improve its thermal and electrical resistance, enhance the ability to contain a thermal event, and prevent arcing. The outer shell 400 can include a polymer matrix and a fiber reinforcement, for example. Additionally, the outer shell 400 can include one or more terminals 410 and/or one or more vents 412, as shown in FIG. 9.

According to one aspect, the polymer matrix comprises a thermoplastic polymer, such as Thermoplastic Polymide (PI), polyphenylene sulfide (PPS), polyetherimide (PEI), polyethersulfone (PES), polyetheretherketone (PEEK), Polyetherketoneketone (PEKK), Polyaryletherketone (PAEK), or Polyethylene terephthalate (PET). Further, the fiber reinforcement could be glass fiber or liquid crystal polymer (LCP). The LCP can comprise a variety of thermotropic liquid crystal polymers, such as Vectra B950 or Xydar SRT-900. The thermoplastic LCP material can comprise a variety of thermotropic liquid crystal polymers, such as any polymer with a main chain consisting of repeating units of aromatic rings linked together or with linking organic groups that can form liquid crystal phases, including commercially available Vectra® grades, Zenite® grades, and Xydar® grades. In which, the polymer matrix comprises a thermoset polymer, such as phenolic, thermosetting polyimide, Phenylethyl-terminated imide (PETI), epoxy, and polyurethane. In these configurations, the fiber reinforcement could be glass fiber.

The outer shell 400 can consist of more than one material. For instance, the outer wall 408 of the outer shell 400 can include a thermoplastic composite that provides a thermal and/or a fire barrier. Some of these materials may meet UL 2596: Test Method for Thermal and Mechanical Performance of Battery Enclosure Materials, including PPS grades Durafide® 6150T73) and PP grades (Stamax™ 30YH570). Additionally or alternatively, the outer wall 408 may be made of a material with polymer matrices such as aluminum hydroxide, magnesium hydroxide, various hydrates, ammonium phosphate, melamine cyanurate, potassium carbonate, Kaolin, hydrated silica, titanium dioxide, clay, calcium silicate, alumina, zirconia, and gypsum, for example. The outer wall 408 of the outer shell 400 may be treated or finished so that one or more prismatic cells 102 can be stacked or arranged adjacent to the first half 402 and/or the second half 404.

The inner wall 406 of the outer shell 400 can include composite materials that provide thermal conductivity, but are electrically insulating, such as those filled with aluminum oxide, boron nitride, or a thermally conductive grade, such as Zenite®, and possess a thermal resistance across the wall no greater than 3.0×10⁻³ m²KW⁻¹ at 65° C.

Manufacturing the outer shell 400 may include protruding, extruding, or blow molding. Additionally or alternatively, the outer shell 400 can be injection or over molded to encapsulate the inner shell 200 and the cooling channels 300. According to one aspect, the outer shell 400 is over-molded onto the inner shell 200 where cooling channels 300 are brazed to the inner shell 200. According to another aspect, the outer shell 400 and cooling channels 300 are profile extruded (i.e., a plastic-metal hybrid extrusion).

In assembly, one or more cavities 500 are formed between the inner shell 200 and the outer shell 400. The one or more cooling channels 300 are arranged in the one or more cavities 500 and define one or more first fluid conduits 502 between the outer shell 400 and a first side 306 of the cooling channels 300 and one or more second fluid conduits 504 between the inner shell 200 and a second side 308 of the cooling channels 300. The one or more first fluid conduits 502 can be configured for a first fluid (e.g., air) and the one or more second fluid conduits 504 can be configured for a second fluid (e.g., coolant). In other words, the second fluid can be different than the first fluid. The elasticity of the prismatic cells 102 and, more specifically, the elasticity of the cooling channels 300, can be tuned through the first and second fluids and/or selecting a material of the cooling channels 300 (e.g., composite, metallic, etc.). Tuning the elasticity of the cooling channels 300 may be desirable to account for compression during cell assembly and expansion during cell charging, for example.

The arrangement of the inner shell 200, the one or more cooling channels 300, and the outer shell 400 provides a rigid or semi-rigid structure that can be reliably transported during manufacturing. In other words, the prismatic cell 102 can include a large cross-sectional area with complex geometry that can provide high structural rigidity.

With reference to FIG. 9, the prismatic cells 102 can include a first or top end cap 602 coupled to the first side wall 106 and a second or bottom end cap 604 coupled to the second side wall 108. The top and bottom end caps 602, 604 can provide structural rigidity, add clearance for the terminals 410 and/or vents 412 of the outer shell 400, and/or serve as cooling channels for additional cooling along the first side wall 106 and the second side wall 108. The top and bottom end caps 602, 604 can be integrated into the inner shell 200 and the outer shell 400 or can be separate components.

With reference to FIGS. 7 and 8, the prismatic cells 102 can include a third or front end cap 606 coupled to the first end 110 and a fourth or rear end cap 608 coupled to the second end 112. The third and fourth end caps 606, 608 can be configured so that fluid can be supplied to the cooling channels 300 and flow from the first end 110 to the second end 112 of the prismatic cells 102. For instance, the third end cap 606 can have a fluid inlet 610 and one or more fluid outlets 612. The fourth end cap 608 can have one or more fluid inlets 614 and a fluid outlet 616. According to at least one aspect, the closures 220 that secure the chamber 214 can be an integral component of the third and fourth end caps 606, 608. Such an arrangement may be desirable for improving manufacturability of the prismatic cell 102, for example.

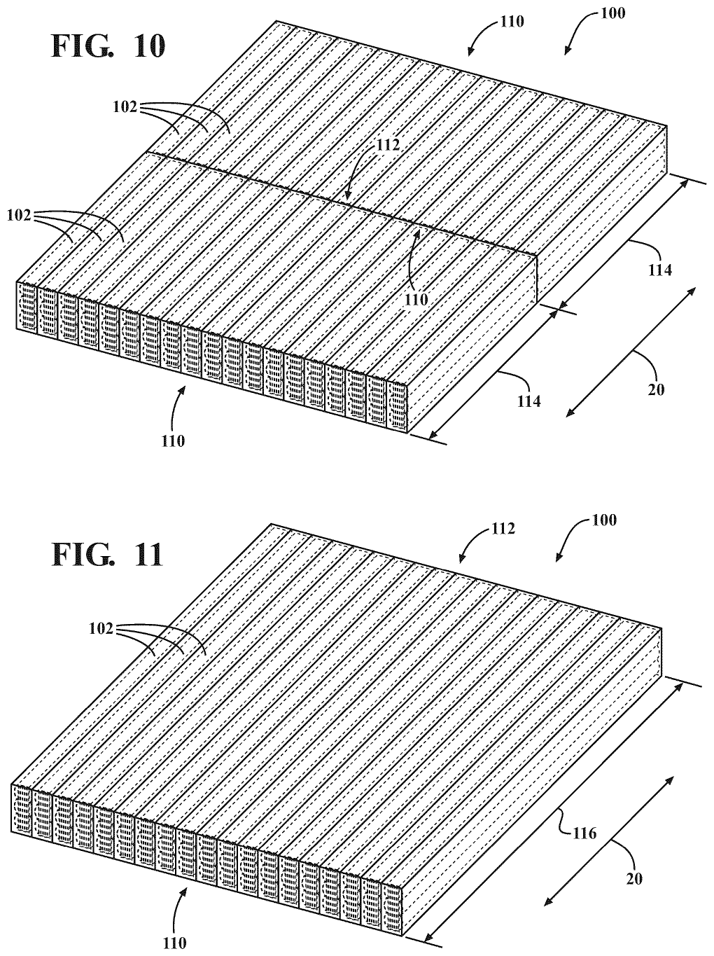

With reference to FIGS. 10 and 11, the battery pack 100 can include one or more of the prismatic cells 102 that extend along the cross-car direction 20 of the vehicle 10. For instance, the battery pack 100 can include one or more prismatic cells 102 that extend about half of the width 114 of the vehicle 10 with respect to the cross-car direction 20. In another variation, the battery pack 100 can include one or more prismatic cells 102 that extend about the full width 116 of the vehicle 10 with respect to the cross-car direction 20. In another configuration, the battery pack 100 can include one or more prismatic cells 102 that extend about half of a length or about the full length of the vehicle 10 with respect to the longitudinal direction 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A prismatic cell having a cell housing, comprising:
an inner shell, comprising:
a first side wall and a second side wall spaced from the first side wall,
an upper wall coupled to the first side wall and the second side wall,
a lower wall coupled to the first side wall and the second side wall, and
an inner side and an outer side opposite the inner side;
an outer shell coupled to the outer side of the inner shell;
one or more cavities between the inner shell and the outer shell; and
one or more cooling channels arranged in the one or more cavities and coupled to the outer side of the inner shell; and
wherein the one or more cavities comprises at least one first fluid conduit on a first side of the cooling channels and at least one second fluid conduit on a second side of the cooling channels.

2. The prismatic cell of claim 1, further comprising one or more electrodes and an electrolyte arranged within the inner shell.

3. The prismatic cell of claim 1, wherein the inner shell further comprises a lining coupled to the inner side.

4. The prismatic cell of claim 3, wherein the lining is made of a fluoropolymer material.

5. The prismatic cell of claim 1, wherein the inner shell further comprises a first closure coupled to the walls at a first end of the cell housing and a second closure coupled to the walls at a second end of the cell housing.

6. The prismatic cell of claim 1, wherein the inner shell is made of a material consisting of an aluminum alloy material or a steel material.

7. The prismatic cell of claim 1, wherein at least a portion of the outer side of the inner shell comprises a mechanically abraded, rough, textured, or chemically modified surface.

8. The prismatic cell of claim 1, wherein the one or more cooling channels are configured to flex in a direction perpendicular to the first and second side walls.

9. The prismatic cell of claim 1, wherein the first fluid conduit is configured for a first fluid and the second fluid conduit is configured for a second fluid different than the first fluid.

10. The prismatic cell of claim 1, wherein the outer shell is a composite material.

11. The prismatic cell of claim 1, wherein the outer shell further comprises one or more terminals.

12. The prismatic cell of claim 11, wherein the outer shell further comprises one or more vents.

13. The prismatic cell of claim 1, further comprising a first end cap coupled to the upper wall and a second end cap coupled to the lower wall.

14. The prismatic cell housing of claim 13, further comprising a third end cap coupled to a front end and a fourth end cap coupled to a rear end.

15. The prismatic cell housing of claim 14, wherein the third end cap comprises a fluid inlet and one or more fluid outlets and the fourth end cap comprises a fluid outlet and one or more fluid inlets.

16. A prismatic cell, comprising:
an inner shell;
an outer shell encapsulating the inner shell;
one or more cavities arranged between the inner shell and the outer shell; and
one or more cooling channels arranged in the one or more cavities and coupled the inner shell; and
wherein the one or more cooling channels are configured to flex between the inner shell and the outer shell.

17. The prismatic cell of claim 16, wherein the one or more cooling channels define a first fluid conduit and a second fluid conduit within the one or more cavities.

18. An electric vehicle, comprising:
a vehicle body extending in a cross-car direction and a fore-aft direction;
an electric motor;
a battery pack connected to the electric motor; and
one or more prismatic cells disposed inside of the battery pack, the one or more prismatic cells comprising:
an inner shell, comprising:
a first side wall and a second side wall spaced from the first side wall,
an upper wall coupled to the first side wall and the second side wall,
a lower wall coupled to the first side wall and the second side wall, and
an inner side and an outer side opposite the inner side;
an outer shell coupled to the outer side of the inner shell;
one or more cavities between the inner shell and the outer shell; and
one or more cooling channels arranged in the one or more cavities and coupled to the outer side of the inner shell.

19. The vehicle of claim 18, wherein the one or more prismatic cells extend about half of a width of the vehicle with respect to the cross-car direction or about half of a length of the vehicle with respect to the fore-aft direction.

20. The vehicle of claim 18, wherein the one or more prismatic cells extend about a width of the vehicle with respect to the cross-car direction or about a length of the vehicle with respect to the fore-aft direction.
